(19) United States
(12) Patent Application Publication
(10) Pub. No.: US 2026/0357618 A1
(43) Pub. Date: Nov. 12, 2026

(54) Door Lock Structure

(71) Applicant: Shanghai Shanmai Electronic Technology Development Co., Ltd., Shanghai (CN)

(72) Inventor: Yongbin Zhang, Shanghai (CN)

(73) Assignee: Shanghai Shanmai Electronic Technology Development Co., Ltd., Shanghai (CN)

(21) Appl. No.: 19/124,942

(22) PCT Filed: Oct. 11, 2023
(86) PCT No.: PCT/CN2023/124017

§ 371 Date: Apr. 28, 2025

(30) Foreign Application Priority Data
May 15, 2023 (CN) 202321161895.8

(51) Int. Cl. E05B 47/00

(52) U.S. Cl. CPC E05B 47/0012; E05B 2047/0017; E05B 2047/0018

(57) ABSTRACT

The disclosure discloses a door lock structure, comprising a lock shell, a bolt, a driving assembly, a limiting member, and a linkage assembly. A chamber is formed in the lock shell, and the lock shell is provided with a bolt channel that connects to the chamber; the bolt is arranged within the chamber and partially extends into the bolt channel, and a first elastic member is provided between the bolt and the chamber wall of the chamber; the driving assembly is arranged within the chamber and acts on the bolt to drive the bolt to move for locking operations; the limiting member is rotatably arranged within the chamber via a second elastic member, the limiting member has a first state and a second state; the linkage assembly is arranged within the chamber and operates in conjunction with the limiting member and the driving assembly.

### CROSS REFERENCE TO RELATED APPLICATIONS

This application claims priority to Chinese Patent Application No. 202321161895.8, titled “Door Lock Structure”, filed on May 15, 2023 with the China National Intellectual Property Administration, the entire contents of which are incorporated herein by reference.

### TECHNICAL FIELD

The application relates to a technology field of home hardware, particularly relating to a door lock structure.

### BACKGROUND

A door lock is a door hardware component installed on doors to maintain privacy. Its basic structure includes a bolt which can expand and contract under external force and cooperates with a buckle box arranged on the door frame to prevent the door from opening due to wind or other accidental forces. The existing technology of door locks has problems such as complex locking and unlocking structures, long waiting times, etc. Moreover, the existing door lock structure requires the driving motor to continuously act on the lock bolt, greatly shortening the service life of the driving motor.

The information disclosed above is intended only to increase the overall understanding of the invention background and should not be construed as an admission or in any form imply that such information constitutes prior art known to those skilled in the art.

### SUMMARY

The purpose of the application is to provide a door lock structure that is simple in design and capable of performing fast locking and unlocking operations.

To achieve the above purpose, the application provides a door lock structure, comprising a lock shell, a bolt, a driving assembly, a limiting member, and a linkage assembly.

An internal chamber is formed in the lock shell, and the lock shell is provided with a bolt channel that connects to the chamber; the bolt is arranged within the chamber and partially extends into the bolt channel, and a first elastic member is provided between the bolt and the chamber wall of the chamber; the driving assembly is arranged within the chamber and acts on the bolt to drive the bolt to move for locking operations; the limiting member is rotatably arranged within the chamber via a second elastic member, the limiting member has a first state in which the bolt is secured in a locked position when the bolt is in the locked position and can maintain the first state under the action of the second elastic member, and the limiting member has a second state in which the bolt is released from the locked position when the limiting member is subjected to force; the linkage assembly is arranged within the chamber and operates in conjunction with the limiting member and the driving assembly, the linkage assembly being capable of applying force to the limiting member under the action of the driving assembly to transition it from the first state to the second state.

In one or more embodiments, the second elastic member is a torsion spring, which continuously provides torque to transition the limiting member from the second state to the first state.

In one or more embodiments, the limiting member comprises a first limiting portion, which is arranged in a hook shape; when the limiting member is in the first state, the top of the bolt is lower than the first limiting portion of the limiting member, and the first limiting portion abuts the top of the bolt.

In one or more embodiments, the bolt comprises a bolt body and a second limiting portion formed at the top of the bolt body, the radial dimension of the second limiting portion is larger than that of the bolt body, and the first limiting portion abuts above the second limiting portion to limit the bolt in the locked position.

In one or more embodiments, the limiting member comprises a first abutting portion; a third limiting portion is formed on the chamber wall of the lock shell, and the third limiting portion cooperates with the first abutting portion to maintain the limiting member in the first state.

In one or more embodiments, the limiting member comprises a second abutting portion; the linkage assembly cooperates with the second abutting portion to drive the limiting member to transition from the first state to the second state.

In one or more embodiments, the driving assembly comprises a driving rod, which comprises a third abutting portion; the linkage assembly comprises a first trigger rod and a second trigger rod; the first trigger rod is rotatably arranged within the chamber and acts on the second trigger rod; the first trigger rod cooperates with the third abutting portion and rotates under the action of the third abutting portion to drive the second trigger rod to move along the axis of the bolt.

In one or more embodiments, a third elastic member is provided between the second trigger rod and the chamber wall of the lock shell, the third elastic member is configured such that when the first trigger rod drives the second trigger rod to move, the third elastic member is in a compressed state.

In one or more embodiments, the driving rod is formed with a groove along its axial direction, the inner wall of the groove near the bolt side forms the third abutting portion, and one end of the first trigger rod is located within the groove.

In one or more embodiments, the driving assembly further comprises a driving motor and a driving screw, the driving motor is fixed within the chamber, the driving screw is threadedly connected to the driving rod, and the rotation of the driving screw drives the driving rod to move, thereby driving the bolt to move.

Compared to the prior art, the door lock structure of the disclosure, through the arrangement of the limiting member, the second elastic member, and the linkage assembly, in cooperation with the driving assembly, can quickly achieve locking and unlocking without prolonged waiting, moreover, the door lock structure is simple and easy to assemble.

### BRIEF DESCRIPTION OF THE DRAWINGS

FIG. 1 is a schematic diagram of a door lock structure according to an embodiment of the disclosure;

FIG. 2 is an internal view of the door lock structure according to an embodiment of the disclosure;

FIG. 3 is a detailed view of the limiting member in the door lock structure according to an embodiment of the disclosure;

FIG. 4 is a detailed view of the driving rod in the door lock structure according to an embodiment of the disclosure;

FIG. 5 is a detailed view of the bolt in the door lock structure according to an embodiment of the disclosure;

FIG. 6 is a detailed view of the linkage assembly in the door lock structure according to an embodiment of the disclosure.

### DETAILED DESCRIPTION

The specific embodiments of the disclosure are described in detail with reference to the accompanying drawings. However, it should be understood that the scope of protection of the disclosure is not limited by the specific embodiments.

Unless otherwise explicitly stated, throughout the specification and claims, the term “comprising” or variations such as “including” or “containing” shall be understood to include the stated elements or components but does not exclude other elements or components.

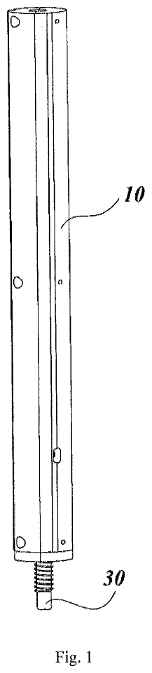

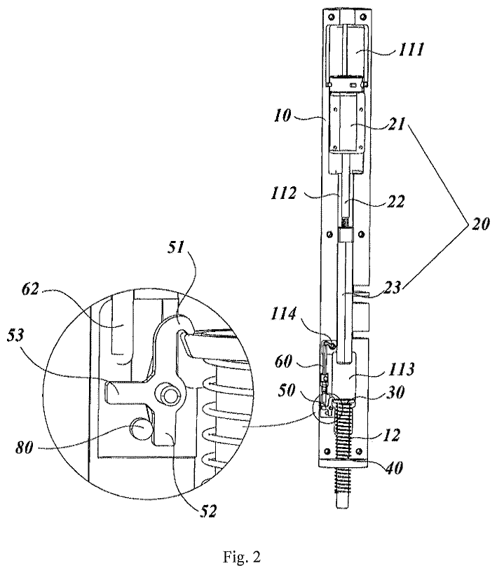

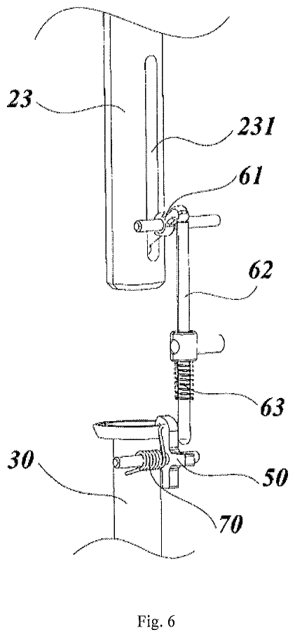

As shown in FIGS. 1 and 2, an embodiment of the present invention provides a door lock structure, which includes a lock shell 10, a driving assembly 20, a bolt 30, a first elastic member 40, a limiting member 50, a linkage assembly 60, and a second elastic member 70 (shown in FIG. 6). The driving assembly 20, the bolt 30, the first elastic member 40, the limiting member 50, the linkage assembly 60, and the second elastic member 70 are all arranged within the lock shell 10. The first elastic member 40 is located between the bolt 30 and the lock shell 10. Some members of the driving assembly 20 moves up and down within the lock shell 10 to push the bolt 30 for locking or to push the linkage assembly 60 for unlocking. The limiting member 50 acts on the bolt 30, cooperating with the driving assembly 20, the linkage assembly 60, the second elastic member 70, and the first elastic member 40 to achieve locking or unlocking of the door lock. The linkage assembly 60 operates in conjunction with the limiting member 50 and the driving assembly 20. The linkage assembly 60 can exert force on the limiting member 50 under the action of the driving assembly 20 to, thereby unlocking the bolt 30. The second elastic member 70 acts on the limiting member 50 to keep the limiting member 50 in the locked state.

The lock shell 10 is generally cylindrical in structure. In other embodiments, it can also be rectangular prism or other shapes, which is not limited in this application. The lock shell 10 is formed by assembling two semi-cylindrical shells, facilitating disassembly and maintenance. An end cover can be added to the top and/or bottom of the semi-cylindrical shells to further limit their position. A chamber and a bolt channel 12 connecting to the chamber are formed within the lock shell 10. In this embodiment, along the axial direction of the lock shell, the chamber sequentially includes an installation chamber 111 at the upper part, a connection channel 112 at the middle part, and a bolt chamber 113 at the lower part. The connection channel 112 connects the installation chamber 111 and the bolt chamber 113. The other end of the bolt chamber 113 is connected to the bolt channel 12 that runs through the lock shell 10. The chamber also includes an accommodation chamber 114 for receiving the linkage assembly 60, the limiting member 50, and the second elastic member 70. The accommodation chamber 114 is located on a side of the bolt chamber 113 and connects to the connection channel 112 and the bolt chamber 113.

The driving assembly 20 is arranged in the installation chamber 111 and partially extends into the connection channel 112 and the bolt chamber 113. The driving assembly 20 includes a driving motor 21, a driving screw 22, and a driving rod 23. The driving motor 21 is fixed in the installation chamber 111, and the driving rod 23 is movably arranged in the connection channel 112 and extends into the bolt chamber 113. One end of the driving screw 22 is connected to the driving motor 21, and the other end is threadedly connected to the driving rod 23. The rotation of the driving screw 22 drives the driving rod 23 to move along the connection channel 112 and the bolt chamber 113, thereby driving the bolt 30 to move for locking operations.

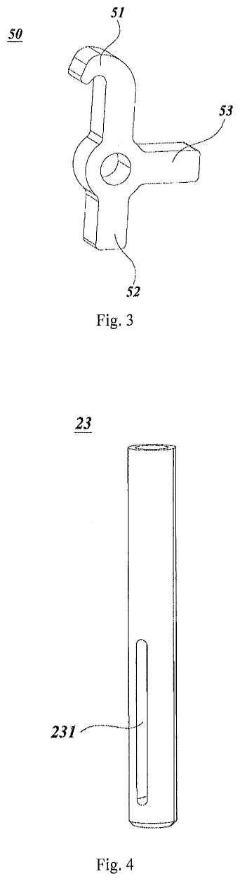

As shown in FIGS. 2, 3, and 6, the limiting member 50, the linkage assembly 60, and the second elastic member 70 all are arranged in the accommodation chamber 114. The limiting member 50 is pivotedly mounted at the connection between the accommodation chamber 114 and the bolt chamber 113 via the second elastic member 70. A part of the limiting member 50 extends into the bolt chamber 113 to act on the bolt 30. The limiting member 50 has a first state in which the bolt 30 is secured in a locked position when the bolt 30 is in the locked position and can maintain the first state under the action of the second elastic member 70. The limiting member 50 also has a second state in which the bolt 30 is released from the locked position when subjected to force. The second elastic member 70 is a torsion spring, with one end fixed to the limiting member 50 and the other end fixed to the chamber wall of the accommodation chamber 114. The torsion spring continuously provides torque to change the limiting member 50 from the second state to the first state.

The limiting member 50 is sequentially provided with a first limiting portion 51, a first abutting portion 52, and a second abutting portion 53 along its rotation direction (the direction of rotation during locking). The first limiting portion 51 is hook-shaped. When the limiting member 50 is in the first state, the top of the bolt 30 is lower than the first limiting portion 51 of the limiting member 50, and the first limiting portion 51 abuts the top of the bolt 30 to limit the bolt 30 in the locked position. The first abutting portion 52 is arranged opposite to the first limiting portion 51. A third limiting portion 80 is formed on the wall of the accommodation chamber 114 of the lock shell 10. Preferably, the third limiting portion 80 is cylindrical extended perpendicular to the locking direction of the bolt 30 and is located in front of the first abutting portion 52 in the locking direction of the limiting member 50. The third limiting portion 80 cooperates with the first abutting portion 52 to keep the limiting member 50 in the first state. For example, when the first limiting portion 51 of the limiting member 50 abuts the top of the bolt 30 to limit the bolt 30, the third limiting portion 80 also abuts the first abutting portion 52, preventing the limiting member 50 from continuously applying force to the bolt 30 under the torque of the second elastic member 70. At the same time, when the limiting member 50 is rotated by the linkage assembly 60 to unlock the bolt 30 and the linkage assembly 60 removes the force acting on the limiting member 50, the limiting member 50 will return to the first state under the torque of the second elastic member 70. At this time, the third limiting portion 80 also abuts the first abutting portion 52, preventing the limiting member 50 from continuing to rotate under the torque of the second elastic member 70 and causing the bolt 30 fails to lock next time. The second abutting portion 53 has an abutting surface and cooperates with the linkage assembly 60 to drive the limiting member 50 from the first state to the second state.

To ensure that the limiting member 50 in the second state does not continue to rotate in the locking direction under the torque of the second elastic member 70 when the linkage assembly removes the external force, the door lock structure of this application uses the third limiting portion 80 and the first abutting portion 52 to keep the limiting member 50 in the first state under the torque of the second elastic member 70.

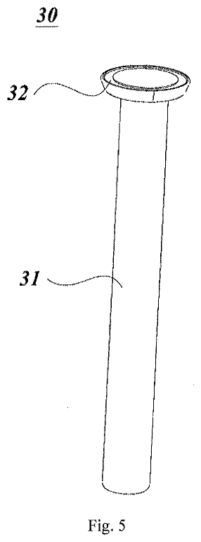

As shown in FIG. 4, the driving rod 23 is generally cylindrical and is formed with a groove 231 along its axial direction. The groove 231 is configured to receive some parts of the linkage assembly 60. The inner wall of the groove 231 near the bolt 30 forms a third abutting portion that can drive some parts of the linkage assembly 60 to move during the upward movement of the driving rod 23, causing the linkage assembly 60 to act on the limiting member 50 for unlocking the door lock.

In other embodiments, a protrusion can be directly formed on the driving rod 23 to constitute the third abutting portion. The protrusion is configured such that when the driving rod 23 moves upward, the protrusion can drive some parts of the linkage assembly 60 to move, causing the linkage assembly 60 to act on the limiting member 50 for unlocking the door lock.

As shown in FIGS. 2 and 5, the bolt 30 is arranged in the bolt chamber 113 and partially extends into the bolt channel 12. The bolt channel 12 can limit the bolt 30 radially, ensuring precise locking or unlocking without jamming. The bolt 30 is also generally cylindrical and includes a bolt body 31 and a second limiting portion 32 formed at the top of the bolt body 31. The minimum radial cross-sectional area of the second limiting portion 32 is larger than that of the bolt body 31. Preferably, the axial cross-section of the bolt 30 is T-shaped. A first elastic member 40 is provided between the second limiting portion 32 of the bolt 30 and the wall of the bolt chamber 113 near the side of the bolt channel 12. The first elastic member 40 is a spring. During locking, the first limiting portion 51 of the limiting member 50 abuts above the second limiting portion 32 of the bolt 30 to limit the bolt 30 in the locked position. At this time, the first elastic member 40 is in a compressed state. During unlocking, the linkage assembly 60 acts on the limiting member 50, causing it to rotate to the second state and release the bolt 30. At this time, the first elastic member 40 assists the bolt 30 in retracting to unlock.

As shown in FIG. 6, the linkage assembly 60 includes a first trigger rod 61, a second trigger rod 62, and a third elastic member 63. The first trigger rod 61 is pivotedly mounted in the accommodation chamber 114 and acts on the second trigger rod 62. The second trigger rod 62 is movably arranged along the axial direction of the lock shell 10 in the accommodation chamber 114 and is located below the first trigger rod 61. A third elastic member 63 is provided between the second trigger rod 62 and the inner wall of the accommodation chamber 114. The first trigger rod 61 includes a first end and a second end arranged opposite to each other. The first end is located in the groove 231 of the driving rod 23, and the second end is located above the second trigger rod 62. The first trigger rod 61 rotates under the action of the driving rod 23, and its second end presses on the second trigger rod 62, driving the second trigger rod 62 to move along the axial direction of the bolt 30 and compressing the third elastic member 63. Preferably, the third elastic member 63 is a spring. The other end of the second trigger rod 62 is located above the second abutting portion 53 of the limiting member 50, moves under the action of the first trigger rod 61 and abuts the abutting surface of the second abutting portion 53, driving the limiting member 50 to rotate.

During locking, the driving rod 23 moves downward to a first position, compressing the first elastic member 40. During this process, one end of the first trigger rod 61 moves within the groove 231 of the driving rod 23 without causing any obstruction. The bolt 30 moves toward the exit of the bolt channel 12 and compresses the first elastic member 40, ultimately causing the first limiting portion 51 of the limiting member 50 to hook onto the top of the bolt 30. The abutting force of the first limiting portion 51 (the torque provided by the second elastic member 70) interacts with the elastic force of the first elastic member 40 and the abutting force provided by the third limiting portion 80 to the first abutting portion 52, keeping the bolt 30 stationary in the first position and achieving the locking of the bolt 30. At this time, the driving motor 21 drives the driving rod 23 to move upward to a certain extent, one end of the first trigger rod 61 still moves within the groove 231 of the driving rod 23 and gradually approaches one end of the groove 231 of the driving rod 23. During unlocking, the driving rod 23 moves upward to a second position. The inner wall of the groove 231 of the driving rod 23 drives one end of the first trigger rod 61 to move upward, causing the first trigger rod 61 to rotate and press on the second trigger rod 62. The second trigger rod 62 moves downward along the axial direction of the bolt 30 and presses on the second abutting portion 53 of the limiting member 50, compressing the third elastic member 63. The limiting member 50 rotates, and its first limiting portion 51 moves away from the top of the bolt 30. The bolt 30 moves upward to the unlocked position under the action of the first elastic member 40. At this time, the driving rod 23 moves downward, and the second trigger rod 62 resets under the action of the third elastic member 63. The limiting member 50 resets to the first state under the torque of the second elastic member 70 and the abutting force provided by the third limiting portion 80 to the first abutting portion 52.

Compared to the prior art, the door lock structure of the disclosure, through the arrangement of the limiting member, the second elastic member, and the linkage assembly, in cooperation with the driving assembly, can quickly achieve locking and unlocking without prolonged waiting. Moreover, the door lock structure is simple and easy to assemble.

The foregoing description of specific exemplary embodiments of the present invention is for the purpose of illustration and explanation. These descriptions are not intended to limit the invention to the precise forms disclosed, and it is clear that many modifications and variations are possible in light of the above teachings. The selection and description of the exemplary embodiments are intended to explain the principles of the invention and their practical applications, enabling those skilled in the art to implement and utilize various exemplary embodiments of the invention as well as various modifications and adaptations. The scope of the disclosure is intended to be defined by the claims and their equivalents.

What is claimed is:

1. A door lock structure comprising:
a lock shell, in which a chamber is formed and a bolt channel connecting to the chamber is arranged;
a bolt, which is arranged within the chamber and partially extends into the bolt channel, wherein a first elastic member is provided between the bolt and the chamber wall of the chamber;
a driving assembly, which is arranged within the chamber and acts on the bolt to drive the bolt to move for locking operations;
a limiting member, which is rotatably arranged within the chamber via a second elastic member, the limiting member having a first state in which the bolt is secured in a locked position when the bolt is in the locked position and can maintain the first state under the action of the second elastic member, and the limiting member having a second state in which the bolt is released from the locked position when the limiting member is subjected to force; and
a linkage assembly, which is arranged within the chamber and operates in conjunction with the limiting member and the driving assembly, the linkage assembly being capable of applying force to the limiting member under the action of the driving assembly to transition the limiting member from the first state to the second state.

2. The door lock structure according to claim 1, wherein the second elastic member is a torsion spring, which continuously provides torque to transition the limiting member from the second state to the first state.

3. The door lock structure according to claim 1, wherein the limiting member comprises a first limiting portion which is arranged in a hook shape; when the limiting member is in the first state, a top of the bolt is lower than the first limiting portion of the limiting member, and the first limiting portion abuts the top of the bolt.

4. The door lock structure according to claim 3, wherein the bolt comprises a bolt body and a second limiting portion formed at the top of the bolt body, a radial dimension of the second limiting portion being larger than that of the bolt body, and the first limiting portion abuts above the second limiting portion to limit the bolt in the locked position.

5. The door lock structure according to claim 1, wherein the limiting member comprises a first abutting portion; and a third limiting portion is formed on the chamber wall of the lock shell, and the third limiting portion cooperates with the first abutting portion to maintain the limiting member in the first state.

6. The door lock structure according to claim 1, wherein the limiting member comprises a second abutting portion; the linkage assembly cooperates with the second abutting portion to drive the limiting member to transition from the first state to the second state.

7. The door lock structure according to claim 1, wherein the driving assembly comprise a driving rod which comprises a third abutting portion; and the linkage assembly comprises a first trigger rod and a second trigger rod, the first trigger rod being rotatably arranged within the chamber and acting on the second trigger rod, the first trigger rod cooperating with the third abutting portion and rotating under the action of the third abutting portion to drive the second trigger rod to move along the axial direction of the bolt.

8. The door lock structure according to claim 7, wherein a third elastic member is provided between the second trigger rod and the chamber wall of the lock shell, the third elastic member being configured such that when the first trigger rod drives the second trigger rod to move, the third elastic member is in a compressed state.

9. The door lock structure according to claim 7, wherein the driving rod is formed with a groove along its axial direction, an inner wall of the groove near a side of the bolt forming the third abutting portion, and one end of the first trigger rod is located within the groove.

10. The door lock structure according to claim 7, wherein the driving assembly further comprises a driving motor and a driving screw, the driving motor being fixed within the chamber, the driving screw being threadedly connected to the driving rod, and rotation of the driving screw drives the driving rod to move, thereby driving the bolt to move.
